(19) United States
(12) Patent Application Publication
(10) Pub. No.: US 2021/0402474 A1
(43) Pub. Date: Dec. 30, 2021

(54) ADDITIVE MANUFACTURING OF METALS

(71) Applicant: HEWLETT-PACKARD DEVELOPMENT COMPANY, L.P., Spring, TX (US)

(72) Inventors: Seongsik Chang, Palo Alto, CA (US); Krzysztof Nauka, Palo Alto, CA (US)

(21) Appl. No.: 16/605,688

(22) PCT Filed: Apr. 30, 2018
(86) PCT No.: PCT/US2018/030177

§ 371 Date: Oct. 16, 2019

(51) Int. Cl. B22F 10/28; B33Y 10/00; B33Y 30/00; B22F 12/90; B22F 10/85; B33Y 50/02

(52) U.S. Cl. CPC B22F 10/28; B33Y 10/00; B33Y 50/02; B22F 12/90; B22F 10/85; B33Y 30/00

(57) ABSTRACT

An example method for additive manufacturing of metals includes spreading a build material including a metal in a sequence of layers. Each layer has a respective thickness, a respective sequence position, and a respective exposed surface to receive radiated energy from a flood energy source prior to spreading of a subsequent layer. A energy function is determined based on the metal, the thickness, and the sequence position of an exposed layer. The energy function defines the radiated energy and includes an intensity profile and a fluence sufficient to cause a consolidating transformation of the build material in the exposed layer. The exposed surface of the exposed layer is exposed to the radiated energy from the flood energy source, causing the consolidating transformation of the build material in the exposed layer.

### BACKGROUND

Additive manufacturing may involve the application of successive layers of material to make solid parts. This is unlike traditional machining processes, which often rely upon the removal of material to create the final part. One example of an additive manufacturing process is three-dimensional (3D) printing. 3D printing may be used to make three-dimensional solid parts from a digital model, and is often used in rapid product prototyping, mold generation, mold master generation, and short run manufacturing. Some 3D printing methods use chemical binders or adhesives to bind build materials together. Other 3D printing methods involve at least partial curing, thermal merging/fusing, melting, sintering, etc. of the build material, and the mechanism for material coalescence may depend upon the type of build material used. For some materials, at least partial melting may be accomplished using heat-assisted extrusion, and for some other materials (e.g., polymerizable materials), curing or fusing may be accomplished using, for example, ultra-violet light or infrared light.

### BRIEF DESCRIPTION OF THE DRAWINGS

Features of examples of the present disclosure will become apparent by reference to the following detailed description and drawings, in which like reference numerals correspond to similar, though perhaps not identical, components. For the sake of brevity, reference numerals or features having a previously described function may or may not be described in connection with other drawings in which they appear.

FIG. 1 is a flow diagram illustrating an example of a method for additive manufacturing of metals disclosed herein;

FIG. 2 is a flow diagram illustrating an example of another method for additive manufacturing of metals disclosed herein;

FIG. 3A is a schematic, side cross-sectional view of an example of a sequence of layers according to the present disclosure;

FIGS. 3B and 3C are schematic and partially cross-sectional views depicting the formation of an intermediate part using an example of a method disclosed herein;

FIG. 4 is a schematic and partially cross-sectional view of an example of a three dimensional (3D) printer disclosed herein;

FIG. 5 is a graph depicting an example of an intensity profile, with intensity (in kW/cm²) shown on the vertical axis and time (in sec.) shown on the horizontal axis;

FIG. 6 is a graph depicting another example of an intensity profile, with intensity (in kW/cm²) shown on the vertical axis and time (in sec.) shown on the horizontal axis; and

FIG. 7 is a scanning electron microscope (SEM) image, at 200 times magnification, of a cross-section of an example intermediate part disclosed herein.

### DETAILED DESCRIPTION

In examples of the methods for additive manufacturing of metals disclosed herein, photonic fusion is used. Photonic fusion may be faster, more efficient, and less expensive than other additive manufacturing processes (e.g., selective laser sintering (SLS), selective laser melting (SLM), scanning electron beam melting, etc.). In examples of photonic fusion as disclosed herein, a build material layer is exposed to radiated energy from a flood energy source. The flood energy source exposes the entire build material layer to the radiated energy without scanning the layer. The radiated energy causes a consolidating transformation of the build material in the exposed layer.

Methods for Additive Manufacturing of Metals

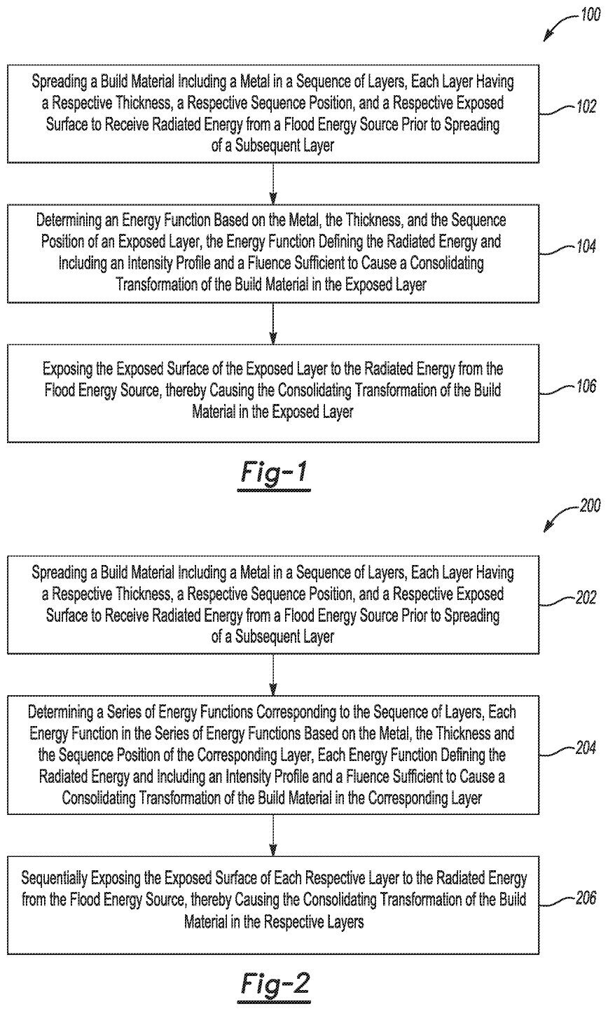

Referring now to FIG. 1 and FIG. 2, examples of methods 100, 200 for additive manufacturing of metals are depicted. Prior to execution of the methods 100, 200 or as part of the methods 100, 200, a controller 28 (see, e.g., FIG. 4) may access data stored in a data store 30 (see, e.g., FIG. 4) pertaining to a 3D part that is to be manufactured.

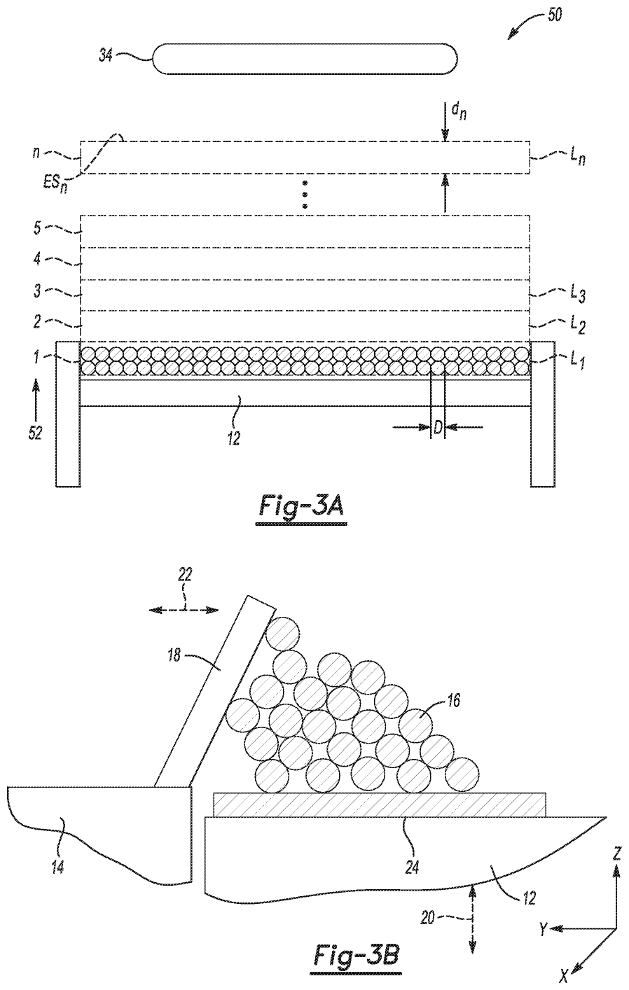

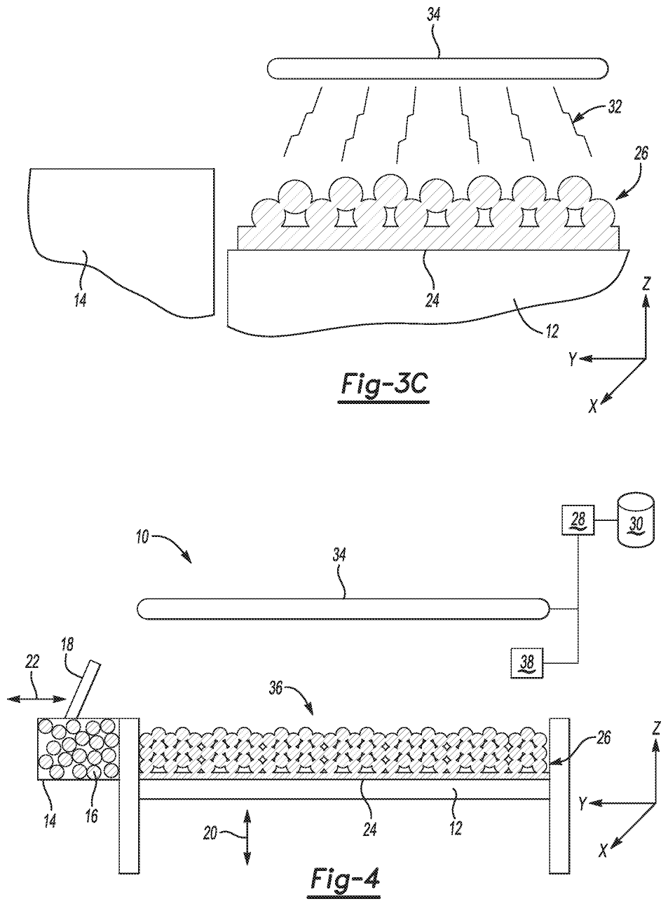

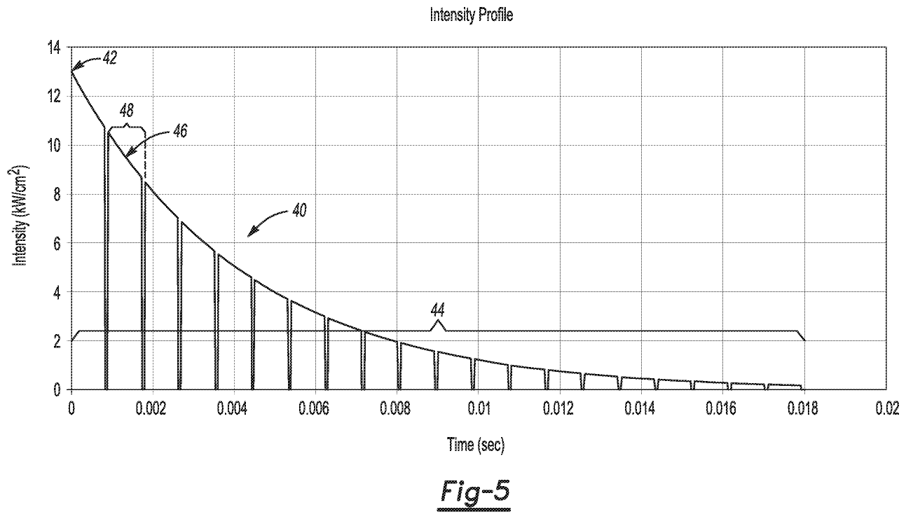

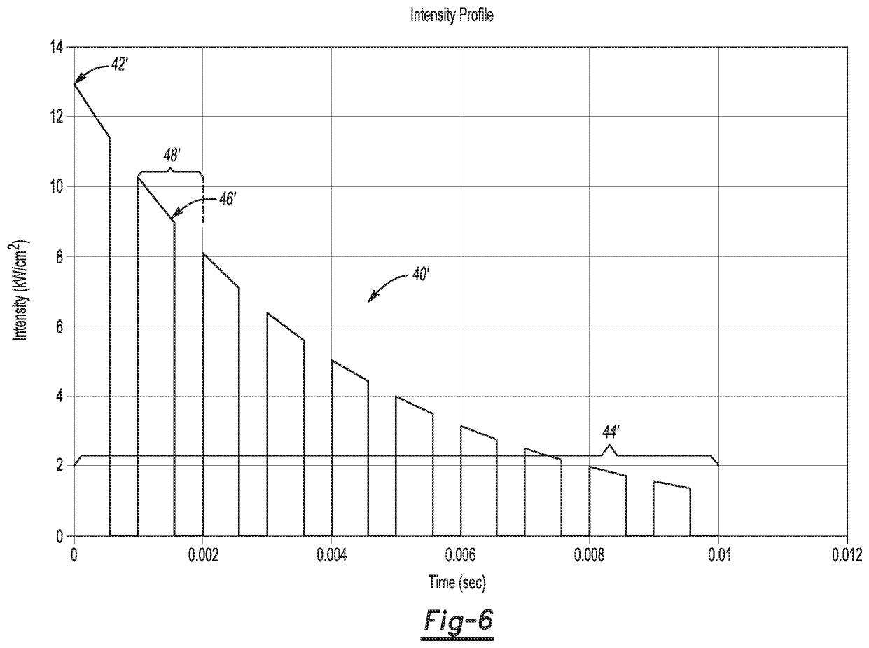

As shown in FIG. 1, an example of the method 100 for additive manufacturing of metals comprises: spreading a build material 16 including a metal in a sequence of layers, each layer having a respective thickness, a respective sequence position, and a respective exposed surface to receive radiated energy 32 from a flood energy source 34 prior to spreading of a subsequent layer (as shown at reference numeral 102 and in FIG. 3B); determining an energy function based on the metal, the thickness, and the sequence position of an exposed layer, the energy function defining the radiated energy 32 and including an intensity profile 40, 40′ (see, e.g., FIGS. 5 and 6) and a fluence sufficient to cause a consolidating transformation of the build material 16 in the exposed layer (as shown at reference numeral 104); and exposing the exposed surface of the exposed layer to the radiated energy 32 from the flood energy source 34, thereby causing the consolidating transformation of the build material 16 in the exposed layer (as shown at reference numeral 106 and in FIG. 3C).

As shown in FIG. 2, an example of the method 200 for additive manufacturing of metals comprises: spreading a build material 16 including a metal in a sequence of layers, each layer having a respective thickness, a respective sequence position, and a respective exposed surface to receive radiated energy 32 from a flood energy source 34 prior to spreading of a subsequent layer (as shown at reference numeral 202 and in FIG. 3B); determining a series of energy functions corresponding to the sequence of layers, each energy function in the series of energy functions based on the metal, the thickness and the sequence position of the corresponding layer, each energy function defining the radiated energy 32 and including an intensity profile 40, 40′ and a fluence sufficient to cause a consolidating transformation of the build material 16 in the corresponding layer (as shown at reference numeral 204); and sequentially exposing the exposed surface of each respective layer to the radiated energy 32 from the flood energy source 34, thereby causing the consolidating transformation of the build material 16 in the respective layers (as shown at reference numeral 206 and in FIG. 3C).

Referring briefly to FIG. 3A, a schematic, side cross-sectional view of an example of a sequence 50 of layers according to the present disclosure is shown. The sequence position k of each layer Lₖ in the sequence 50 is shown in the column of numbers indicated by reference numeral 52. The sequence position k is indicated by natural numbers beginning with 1, incremented by 1, and ending with n. Although the example of the sequence 50 of layers shown in FIG. 3A has 5 expressly numbered layers, it is to be understood that the quantity of layers in the sequence 50 of layers may be any natural number greater than 1 in examples of the present disclosure. Each layer Lₖ in the sequence 50 of layers may be uniquely identified herein by the letter “L” with the corresponding sequence position k written as a subscript k. For example, each layer Lₖ may be an element of a sequence {L₁, L₂, L₃, . . . Lₙ}. Similarly, the thickness dₖ corresponding to the layer Lₖ may be an element of a sequence {d₁, d₂, d₃, . . . , dₙ}. The exposed surface ESₖ corresponding to the layer Lₖ may be an element of a sequence {ES₁, ES₂, ES₃, . . . , ESₙ}.

It may be convenient to use the following notation:

E={[I(t)₁,f₁],[I(t)₂,f₂],[I(t)₃,f₃], . . . ,[I(t)ₙ,fₙ]} (Eq. 1)

In Eq. 1, E is a series of energy functions [I(t)ₖ fₖ]; each Intensity profile I(t)ₖ corresponds to sequence position k, each Intensity profile is a function of time (t); each fluence fₖ corresponds to sequence position k; and the sequence positions k uniquely correspond to a layer Lₖ. The Intensity profiles may be collectively represented as I={[I(t)₁], [I(t)₂], [I(t)₃], . . . , [I(t)ₙ]}; and the fluences may be collectively represented as f={f₁, f₂, f₃, . . . , fₙ}.

As shown at reference numeral 102 in FIG. 1 and at reference numeral 202 in FIG. 2, the methods 100, 200 include spreading a build material 16 in a sequence 50 of layers. The build material 16 includes a metal. Example compositions of the build material 16 are described below.

An enlarged (as compared to FIG. 3A), schematic, and partially cross-sectional cutaway view of the build material 16 being spread in one layer of the sequence 50 of layers is shown in FIG. 3B. In the example shown in FIG. 3B, a 3D printer (e.g., 3D printer 10 shown in FIG. 4) may be used to apply the build material 16. The 3D printer 10 may include a build area platform 12, a build material supply 14 containing the build material 16, and a build material distributor 18.

The build area platform 12 receives the build material 16 from the build material supply 14. The build area platform 12 may be moved in the directions as denoted by the opposed arrows 20, e.g., along the z-axis, so that the build material 16 may be delivered to the build area platform 12 or to a previously formed layer (e.g., layer 24). In an example, when the build material 16 is to be delivered, the build area platform 12 may be programmed to advance (e.g., downward) enough so that the build material distributor 18 can push the build material 16 onto the build area platform 12 to form a substantially uniform layer of the build material 16 thereon. The build area platform 12 may also be returned to its original position, for example, when a new part is to be built.

The build material supply 14 may be a container, bed, or other surface that is to position the build material 16 between the build material distributor 18 and the build area platform 12.

The build material distributor 18 may be moved in the directions as denoted by the two-headed arrow 22, e.g., along the y-axis, over the build material supply 14 and across the build area platform 12 to spread the layer of the build material 16 over the build area platform 12 or a previously formed layer. The build material distributor 18 may also be returned to a position adjacent to the build material supply 14 following the spreading of the build material 16. The build material distributor 18 may be a blade (e.g., a doctor blade), a roller, a combination of a roller and a blade, and/or any other device capable of spreading the build material 16 over the build area platform 12. For instance, the build material distributor 18 may be a counter-rotating roller. In some examples, the build material supply 14 or a portion of the build material supply 14 may translate along with the build material distributor 18 such that build material 16 is delivered continuously to the build material distributor 18 rather than being supplied from a single location at the side of the 3D printer 10 as depicted in FIG. 3B.

As shown in FIG. 3B, the build material supply 14 may supply the build material 16 in a position so that the build material 16 is ready to be spread onto the build area platform 12 or a previously formed layer. The build material distributor 18 may spread the supplied build material 16 onto the build area platform 12 or a previously formed layer. The controller 28 may process “control build material supply” data, and in response control the build material supply 14 to appropriately position the particles of the build material 16, and may process “control spreader” data, and in response, control the build material distributor 18 to spread the supplied build material 16 over the build area platform 12 to form the sequence 50 of layers thereon.

It is to be understood that the number of layers Lₖ in the sequence 50 may depend, in part, on the 3D part to be manufactured, and/or the thickness dₖ of each layer Lₖ. Further, each layer Lₖ has a respective thickness dₖ, a respective sequence position k, and a respective exposed surface ESₖ to receive radiated energy 32 from a flood energy source 34 prior to spreading of a subsequent layer Lₖ₊₁.

The thickness dₖ of each layer Lₖ may be substantially the same as the thickness d₍ₙₒₜₖ₎ of each other layer L₍ₙₒₜₖ₎ in the sequence 50 of layers; or the thickness dₖ of one or more of the layers Lₖ may be different than the thickness d₍ₙₒₜₖ₎ of other layers L₍ₙₒₜₖ₎ in the sequence 50 of layers.

Each layer Lₖ may have a substantially uniform thickness dₖ across the build area platform 12. In an example, each layer Lₖ has a thickness dₖ ranging from about 90 μm to about 110 μm, although thinner or thicker layers may be used. For example, each layer Lₖ may have a thickness dₖ ranging from about 50 μm to about 200 μm. In another example, each layer Lₖ has a thickness dₖ ranging from about 30 μm to about 300 μm. In still another example, each layer Lₖ has a thickness dₖ ranging from about 20 μm to about 500 μm. In an example, the respective thickness dₖ of each layer Lₖ may be about 2× (i.e., 2 times) the diameter D (see FIG. 3A) of a particle of the build material 16 at a minimum for finer part definition. In some examples, the layer thickness dₖ may be about 1.2× the diameter D of a particle of the build material 16.

The respective sequence position k of each layer Lₖ corresponds to the order in which the sequence 50 of layers is applied. As such, the layer L₁ applied directly on the build area platform 12 has a sequence position of 1; the layer L₂ having a sequence position of 2, is applied directly on the layer L₁, which has the sequence position of 1; and so on. In other words, each layer Lₖ applied after the first layer L₁ (i.e., the layer L₁ with the sequence position of 1) has a sequence position equal to k, where k minus 1 is equal to the sequence position of the immediately preceding layer. The term “preceding” refers to layers formed (spread and exposed to the radiated energy 32) before the current layer Lₖ. As such, preceding layers are below/underneath the current layer. The term “subsequent” refers to layers formed after the current layer Lₖ. As such, subsequent layers are to be applied above/on top of the current layer Lₖ.

As mentioned above, each layer Lₖ has an exposed surface ESₖ to receive radiated energy 32 from a flood energy source 34 prior to spreading of a subsequent layer Lₖ₊₁. The exposed surface ESₖ of each layer Lₖ is the surface that is opposed to the surface that is in contact with build area platform 12 or immediately preceding layer Lₖ₋₁, and is parallel to the surface of the build area platform 12. Prior to the spreading of the subsequent layer Lₖ₊₁, the exposed surface ESₖ of each layer Lₖ can be exposed to the radiated energy 32 from the flood energy source 34. After the spreading of the subsequent layer Lₖ₊₁, the surface of each layer that was exposed is covered with the subsequent layer Lₖ₊₁.

As shown at reference numeral 104, the method 100 includes determining an energy function based on the metal of the exposed layer Lₖ, the thickness dₖ of the exposed layer Lₖ, and the sequence position k of the exposed layer Lₖ. As shown at reference numeral 204, the method 200 includes determining a series of energy functions, each energy function in the series of energy functions based on the metal of the corresponding layer Lₖ, the thickness dₖ of the corresponding layer Lₖ, and the sequence position k of the corresponding layer Lₖ. As the metal, the thickness dₖ, and/or the sequence position k of the layers may vary from layer to layer, the energy function for one or more of the layers Lₖ may be different than the energy function for other layers Lₙₒₜₖ in the sequence 50 of layers. For example, the energy function for the first layer L₁ (i.e., the layer L₁ having the sequence position of 1) may be different than the energy function for each subsequent layer (i.e., each layer having a sequence position greater than 1).

Each energy function defines the radiated energy 32 and includes an intensity profile 40, 40′ and a fluence sufficient to cause a consolidating transformation of the build material 16 in the exposed/corresponding layer Lₖ. As used herein, a “consolidating transformation” refers to the at least partial melting or sintering of the build material 16. In some examples (such as, when the exposed/respective layer Lₖ has a sequence position greater than 1), the consolidating transformation includes the neck-to-neck sintering of at least 50 percent of particles in the build material 16 of the exposed/respective layer Lₖ. In another example (such as when the exposed/respective layer Lₖ has a sequence position of 1), the consolidating transformation is the melting of at least 70 percent of the particles in the build material 16 of the exposed/respective layer Lₖ. In still another example, the consolidating transformation includes the fusion between layers (e.g., between an exposed/respective layer Lₖ having a sequence position greater than 1 and the layer Lₖ₋₁ having a sequence position k−1, one less than the sequence position k of the exposed/respective layer Lₖ).

In one specific example, the consolidating transformation includes: a neck-to-neck sintering of at least 50 percent of particles in the build material 16 of the exposed layer Lₖ having a sequence position greater than 1; and a fusion between the exposed layer Lₖ having a sequence position greater than 1 and the layer Lₖ₋₁ having a sequence position k−1 one less than the sequence position k of the exposed layer Lₖ; and the consolidating transformation is a melting of at least 70 percent of the particles in the build material 16 of a layer L₁ having a sequence position of 1.

In another specific example, the consolidating transformation includes: a neck-to-neck sintering of at least 50 percent of particles in the build material 16 of the respective layer Lₖ having a sequence position greater than 1; and a fusion between the respective layer Lₖ having a sequence position greater than 1 and the layer Lₖ₋₁ having a sequence position k−1 one less than the sequence position k of the respective layer Lₖ; and the consolidating transformation is a melting of at least 70 percent of the particles in the build material 16 of a layer L₁ having a sequence position of 1.

As used herein, the term “intensity” refers to the power per area (e.g., kilowatts per square centimeter (kW/cm²)) of the radiated energy 32. The term “fluence,” as used herein, refers to the total energy per area (e.g., Joules per square centimeter (J/cm²)) of the radiated energy 32. The area referred to in the intensity and the fluence is the area of exposed surface ESₖ that receives the radiated energy 32.

As used herein, an “intensity profile” 40, 40′ refers to the intensity of the radiated energy 32 over a set duration 44, 44′. As such, fluctuations in the intensity of the radiated energy 32 that may occur throughout the emission of the radiated energy 32 are conveyed by the intensity profile 40, 40′. In one example of the intensity profile 40, 40′, the intensity may undergo exponential decay as the radiated energy 32 is emitted. In another example of the intensity profile (not shown), the intensity may oscillate in a wave as the radiated energy 32 is emitted. In yet another example of the intensity profile (not shown), the intensity may remain constant for the duration of the intensity profile.

In some examples, the intensity profile 40, 40′ includes an intensity, a profile duration 44, 44′, and a number of profile slices 46, 46′. One example of an intensity profile 40 is shown in FIG. 5. In an example, the intensity profile 40, shown in FIG. 5, may be used to cause the consolidating transformation of build material 16 including AlSi10Mg powder. In another example, the intensity profile 40 shown in FIG. 5 may be produced using a xenon pulse lamp as the flood energy source 34 at a voltage of 700 V. Another example of an intensity profile 40′ is shown in FIG. 6. In an example, the intensity profile 40′ shown in FIG. 6 may be used to cause the consolidating transformation of build material 16 including TiAl6V4 powder. In another example, the intensity profile 40′ shown in FIG. 6 may be produced using a xenon pulse lamp as the flood energy source 34 at a voltage of 700 V. In FIGS. 5 and 6, intensity, in kW/cm², is shown on the vertical axis, and time, in seconds (sec.), is shown on the horizontal axis.

The intensity of the intensity profile 40, 40′ may be the peak intensity 42, 42′. In an example, the flood energy source 34 is a source (e.g., xenon pulse lamp) that creates an exponentially decaying intensity (see, e.g., FIGS. 5 and 6), and the intensity of the intensity profile 40, 40′ is the peak intensity 42, 42′.

In the example shown in FIG. 5, the intensity of the intensity profile 40 is the peak intensity 42, and the peak intensity 42 is about 13 kW/cm². In the example shown in FIG. 6, the intensity of the intensity profile 40′ is the peak intensity 42′, and the peak intensity 42′ is also about 13 kW/cm². While the peak intensity 42, 42′ depicted in FIGS. 5 and 6 is shown to be about 13 kW/cm², it is to be understood that other peak intensities (e.g., 8 kW/cm², 10 kW/cm², 15 kW/cm², 17 kW/cm², etc.) may be used. In an example, the peak intensity 42, 42′ of the intensity profile 40, 40′ ranges from about 5 kW/cm² to about 100 kW/cm².

The profile duration 44, 44′ is the amount of time for which a set emission of the radiated energy 32 lasts. It is to be understood that the intensity profile 40, 40′ may include periods of time where zero energy is emitted, for example, in an intensity profile 40, 40′ that is divided into profile slices 46, 46′, the profile slices 46, 46′ having a duty cycle less than 100 percent. In some examples, the profile duration 44, 44′ may correspond to the emission capacity of the flood energy source 34. In the example shown in FIG. 5, the profile duration 44 is about 0.018 seconds. In the example shown in FIG. 6, the profile duration 44′ is about 0.01 seconds. While the profile duration 44, 44′ depicted in FIG. 5 and FIG. 6 is shown to be about 0.018 seconds and about 0.01 seconds, respectively, it is to be understood that other profile durations (e.g., 0.008 seconds, 0.013 seconds, 0.015 seconds, 0.02 seconds, etc.) may be used. In an example, the intensity profile 40, 40′ has a profile duration 44, 44′ ranging from about 100 microseconds (psec) to about 30 milliseconds (msec).

The intensity profile 40, 40′ may be divided into profile slices 46, 46′. As an example, dividing an intensity profile 40, 40′ into profile slices 46, 46′ may allow cooling and reduce the temperature of the flood energy source 34 and/or the exposed/respective layer Lₖ. As shown in FIGS. 5 and 6, the intensity profile 40, 40′ may be divided into the profile slices 46, 46′ by very briefly pausing (e.g., for 0.08 milliseconds, for 0.44 milliseconds, etc.) the emission of energy 32 from the flood energy source 34. Each profile slice 46, 46′ includes an emission and a pause. The amount of time for which each profile slice 46, 46′ lasts (including both the emission and the pause) is the slice width 48, 48′. The pauses may occur at set intervals, and each pause may be for the same amount of time. As such, the slice width 48, 48′ may be the same for each profile slice 46, 46′. In the example shown in FIG. 5, each profile slice 46 has a slice width 48 of about 0.9 milliseconds. In the example shown in FIG. 6, each profile slice 46′ has a slice width 48′ of about 1 millisecond. While the slice width 48, 48′ depicted in FIG. 5 and FIG. 6 is shown to be about 0.9 milliseconds and about 1 millisecond, respectively, it is to be understood that other slice widths (e.g., 0.6 milliseconds, 0.8 milliseconds, 1.2 milliseconds, 1.5 milliseconds, etc.) may be used. In an example, the slice width 48, 48′ ranges from about 0.2 milliseconds to about 20 milliseconds. In another example, the slice width 48, 48′ ranges from about 0.2 milliseconds to about 30 milliseconds.

When the intensity profile 40, 40′ is divided into profile slices 46, 46′, the duty cycle of the intensity profile 40, 40′ indicates the percentage of each profile slice 46, 46′ during which energy is emitted. In the example shown in FIG. 5, the duty cycle of the intensity profile 40 is about 91%. As such, during each profile slice 46, energy is emitted for about 0.82 milliseconds (91% of a 0.9 milliseconds slice width 48) and the pause lasts for about 0.08 milliseconds (0.9 milliseconds minus 0.82 milliseconds). In the example shown in FIG. 6, the duty cycle of the intensity profile 40′ is about 56%. As such, during each profile slice 46′, energy is emitted for about 0.56 milliseconds (56% of a 1 millisecond slice width 48′) and the pause lasts for about 0.44 milliseconds (1 millisecond minus 0.56 milliseconds). While the duty cycle of the intensity profile 40, 40′ depicted in FIG. 5 and FIG. 6 is shown to be about 91% and about 56%, respectively, it is to be understood that other duty cycles (e.g., 40%, 65%, 80%, 95%, etc.) may be used. In an example, the duty cycle of the intensity profile 40, 40′ ranges from about 5% to 100%. When the duty cycle is 100%, there are no pauses and the intensity profile 40, 40′ is not divided into profile slices 46, 46′.

The number of profile slices 46, 46′ in the intensity profile 40, 40′ is equal to the number of pauses. It is to be understood that while the last pause comes at the end of the intensity profile 40, 40′, and may be indistinguishable from the end of the set emission, it is part of the intensity profile 40, 40′ (as shown in FIGS. 5 and 6). As such, the length of the last pause is included in the profile duration 44, 44′ and the slice width 48, 48′ of the last profile slice 46, 46′. In the example shown in FIG. 5, the intensity profile 40 includes 20 profile slices 46. In the example shown in FIG. 6, the intensity profile 40′ includes 10 profile slices 46′. While the number of profile slices 46, 46′ depicted in FIG. 5 and FIG. 6 is shown to be 20 and 10, respectively, it is to be understood that other numbers of profile slices 46, 46′ (e.g., 2, 15, 18, 25, etc.) may be used. In an example, the number of profile slices 46, 46′ ranges from 1 to 100. When the number of profile slices 46, 46′ is 1, there are no pauses, the duty cycle is 100%, and the intensity profile 40, 40′ is not divided into profile slices 46, 46′.

The fluence of the intensity profile 40, 40′ is equal to the area under the intensity profile in the time domain. In other words, the fluence is equal to the total amount of energy applied per area when the radiated energy 32 is emitted from the flood energy source 34 according to the intensity profile 40, 40′. In the example shown in FIG. 5, the fluence is about 50 J/cm². In the example shown in FIG. 6, the fluence is about 30 J/cm². While the fluence depicted in FIG. 5 and FIG. 6 is about 50 J/cm² and about 30 J/cm², respectively, it is to be understood that other fluences (e.g., 25 J/cm², 35 J/cm², 45 J/cm², 55 J/cm², etc.) may be achieved with other intensity profiles 40, 40′. As an example, a larger peak intensity 42, 42′, a longer profile duration 44,44′, and/or a higher duty cycle may be used to achieve a larger fluence. In an example, the fluence of the radiated energy 32 from the flood energy source 34 ranges from about 10 J/cm² to about 70 J/cm². In another example, the fluence of the radiated energy 32 from the flood energy source 34 ranges from about 10 J/cm² to about 100 J/cm².

In some examples, the energy function for the exposed/corresponding layer Lₖ consists of a single intensity profile 40, 40′. In other examples, the energy function for the exposed/corresponding layer Lₖ includes multiple stages of the intensity profile 40, 40′. In these examples, the flood energy source 34 may repeatedly emit the radiated energy 32 defined by the intensity profile 40, 40′ in a predetermined number of stages at a repetition rate. In an example, the predetermined number of stages ranges from 1 to 100. In another example, the repetition rate has a period of about 0.1 second to about 10 seconds.

One energy function corresponds to each layer Lₖ in the sequence 50 of layers. The intensity profile(s) I(t)ₖ, 40, 40′ and fluence fₖ of each energy function [I(t)ₖ, fₖ] is such that the radiated energy 32 defined by the energy function [I(t)ₖ, fₖ] is sufficient to cause the consolidating transformation of the build material 16.

In some examples, the determining of each energy function includes: determining a minimum energy to sinter the exposed/corresponding layer Lₖ; determining an absorptivity of the exposed/corresponding layer Lₖ for the energy radiated by the flood energy source 34; determining an amount of energy propagated to other layers Lₙₒₜₖ from or through the exposed/corresponding layer Lₖ; and determining a maximum allowable intensity to limit Marangoni effect cracks in the exposed/corresponding layer Lₖ.

In one specific example, the intensity profile 40, 40′ includes: an intensity; a profile duration 44, 44′; and a number of profile slices 46, 46′; and the determining the energy function includes: determining a minimum energy to sinter the exposed layer Lₖ; determining an absorptivity of the exposed layer Lₖ for the radiated energy 32; determining an amount of energy propagated to other layers Lₙₒₜₖ from or through the exposed layer Lₖ; and determining a maximum allowable intensity to limit Marangoni effect cracks in the exposed layer Lₖ.

In another specific example, the intensity profile 40, 40′ of each energy function includes: an intensity; a profile duration 44, 44′; and a number of profile slices 46, 46′; and the determining the series of energy functions includes: determining a minimum energy to sinter the corresponding layer Lₖ; determining an absorptivity of the corresponding layer Lₖ for the radiated energy 32; determining an amount of energy propagated to other layers Lₙₒₜₖ from or through the corresponding layer Lₖ; and determining a maximum allowable intensity to limit Marangoni effect cracks in the corresponding layer Lₖ.

In an example, the minimum energy to sinter the exposed layer Lₖ is determined from: a heat capacity of the build material 16; a heat of fusion of the build material 16; a melting point of the build material 16; a packing density of the build material 16; and a thickness dₖ of the exposed layer Lₖ.

In an example, the amount of energy propagated to other layers Lₙₒₜₖ from or through the exposed layer Lₖ is determined from a thermal conductivity of the build material 16. For example, a build material 16 having a higher thermal conductivity (e.g., the thermal conductivity of AlSi10Mg, about 170 W/m/K) may propagate more of the energy received over a short time. If more of the energy is propagated to a lower layer, the temperature of the lower layer may be higher, and the temperature of the upper layer may be lower. In other words, the lower layers of high conductivity materials may act as heat sinks, such that the intensity or fluence in a particular time period that is sufficient to sinter the exposed layer Lₖ is increased. As another example, a build material 16 having a lower thermal conductivity (e.g., the thermal conductivity of 316 Stainless Steel (SS316) powder is about 0.132 W/m/K, and the thermal conductivity of solid SS316 is about 15 W/m/K.) may propagate less of the energy received over a short time. If less of the energy is propagated to a lower layer, the temperature of the lower layer may be lower, and the temperature of the upper layer may be higher. In other words, the lower layers of lower conductivity materials may be less effective as heat sinks, such that the intensity or fluence in a particular time period that is sufficient to sinter the exposed layer Lₖ is reduced.

In other examples (e.g., when the propagation of energy is slower than the consolidating transformation of the layer Lₖ), the amount of energy propagated to other layers Lₙₒₜₖ from or through the exposed/corresponding layer Lₖ may be determined from the minimum energy to sinter the exposed/corresponding layer Lₖ and a thermal conductivity of the build material 16.

A large amount of energy propagated to other layers Lₙₒₜₖ from or through the exposed/corresponding layer Lₖ may be compensated in the determination of the energy function. For example, the fluence may be made larger by increasing the slice width 48, 48′ and/or the duty cycle of the intensity profile 40, 40′. Another way to increase the fluence is to increase the intensity of the intensity profile 40, 40′ with or without adjusting the slice width 48, 48′ or duty cycle.

In one specific example, the minimum energy to sinter the corresponding layer Lₖ is determined from: a heat capacity of the build material 16; a heat of fusion of the build material 16; a melting point of the build material 16; a packing density of the build material 16; and a thickness dₖ of the corresponding layer Lₖ; and the amount of energy propagated to other layers Lₙₒₜₖ from or through the corresponding layer Lₖ is determined from a thermal conductivity of the build material 16.

In some examples, the determining of each energy function does not include determining an amount of energy propagated to the exposed/corresponding layer Lₖ from or through the previous layer(s). It is believed that by the time the build material 16 is spread to form the exposed/corresponding layer Lₖ, the energy from the radiated energy 32 (to which the previous layer(s) were exposed) has caused the consolidating transformation of the previous layer(s) and/or has dissipated into the surrounding environment. As such, it is believed that substantially no energy propagated to exposed/corresponding layer Lₖ from or through the previous layers.

In some examples, the determining the energy function includes determining the maximum allowable intensity to limit Marangoni effect cracks in the exposed/corresponding layer Lₖ. The Marangoni effect is a convection process of material migration due to area variation of surface tension. The local mass density of an exposed/corresponding layer Lₖ may vary throughout the layer Lₖ due, in part, to variations in particle size, packing density, etc. When the exposed/corresponding layer Lₖ is exposed to radiated energy 32, variation in local mass density may cause variation in temperature within the layer Lₖ, which in turn, may cause variation in the surface tension of melted metal within the layer Lₖ. Due to the Marangoni effect, melted metal with a lower surface tension may migrate towards melted metal with a higher surface tension. This migration may result in the formation of Marangoni effect cracks, which may be undesirable.

Without being held bound to any theory, it is believed that samples with higher surface temperatures during melting may have a greater tendency to incur Marangoni effect cracks. A rate of temperature rise of the exposed surface ESₖ depends on the difference between the rate of energy going into the exposed surface ESₖ and a rate of energy going out of the exposed surface ESₖ as stated in the following equation:

$$ρ cd \frac{dT}{dt} = A ( T ) * I ( T ) - Q ( T ) \qquad ( Eq . 2 )$$

In Eq. 2, ρ is density, c is specific heat, d is thickness of the powder, T is temperature of the powder, A(T) is absorptivity, I(T) is intensity of light, Q(T) is thermal loss. The thermal loss, also called the cooling, is relatively constant in the temperature range. Therefore, as intensity I(T) is higher, the heat input is higher, and therefore, temperature will increase at a faster rate (dT/dt) because cooling rate Q(T) is relatively insensitive to temperature in this range. A(T) will also change with temperature because a degree of sintering or melting will change a behavior of multiple scattering of light, therefore absorptivity. As the surface melts and becomes smoother, more light is reflected away from the surface, and less light is trapped between the particles. After melting occurs at the surface, the absorptivity A(T) may drop, making subsequent repeated stages of the intensity profile 40, 40′ less effective for adding energy and increasing temperature.

In some examples, the peak intensity 42, 42′ of the intensity profile 40, 40′ may be made smaller to compensate for the Marangoni effect. In one of these examples, a peak intensity 42, 42′ of the intensity profile 40, 40′ is less than a predetermined maximum intensity to limit Marangoni effect cracks in the exposed/corresponding layer Lₖ.

In some examples, the determining of energy function(s) includes determining the intensity profile 40, 40′. In an example (e.g., when the layer L₁ has a sequence position of 1), determining the intensity profile 40, 40′ may include determining a fluence that is sufficient to melt the entire layer Lₖ. The fluence that is sufficient to melt the entire layer Lₖ may be determined, in part, by using specific heat and heat of fusion relationships for the build material. It is to be understood that the following equations may be used to calculate an approximation or boundary for the fluence that may be made more accurate by for example, considering other factors (such as rate of heat transfer, time for consolidation, absorptivity changes, spectral sensitivity, losses and/or any additional factors that contribute to the accuracy of calculations), or using a consolidation sensor:

q=H_{f}m+c mΔT=m(H_{f}+cΔT) (Eq. 3)

q=Energy per unit area

H_{f}=heat of fusion (J/g)

m=mass (g) per unit area

c=specific heat (J/g/K)

ΔT=Tₘ−Tᵣₒₒₘ (Eq. 4)

Tₘ=Melting Point

Tᵣₒₒₘ=Room Temperature=25° C.

m=ρ_{b}V (Eq. 5)

ρ_{b}=bulk density of the powder

ρ_{b}=ρη (Eq. 6)

ρ=particle density of metal (g/cm³)

η=packing density (packing fraction) (dimensionless)

v=volume

v=D*A (Eq. 7)

D=diameter of spherical particle (thickness of a single layer) (cm)

A=unit area (cm²)

Substituting Eq. 6 and Eq. 7 into Eq. 5:

m=ρηDA (Eq. 8)

Assuming a single layer of spherical particles, packed in cubic lattice:

η=π/6=0.5236

Let D=40 μm=0.004 cm; let A=1 cm².

In one example, the build material 16 is an AlSi10Mg powder. For AlSi10Mg: H_{f}=321 (J/g); c=0.897 (J/g/K); Tₘ=660° C.; and p=2.68 g/cm³.

### Applying Eq. 8:

m=2.68 (g/cm³)*0.5236*0.004 (cm)*1 (cm²)

m=0.0056 (g)

### Applying Eq. 4:

ΔT=660° C.−25° C.=635° C.

### Applying Eq. 3:

q=0.0056 (g)*[321 (J/g)+0.897 (J/g/K)*635° C.]

q=0.0056 (g)*[321 (J/g)+570 (J/g)]

q=0.0056 (g)*891 (J/g)

q=4.99 J per unit area for a layer that is 40 μm thick.

A portion of the fluence is actually input as energy into the build material 16 because the absorptivity of the build material 16 is less than 1. Absorptivity (A) of AlSi10Mg powder is about 0.3.

fluence*A=q (Eq. 9)

fluence=q/A (Eq. 10)

Applying Eq. 10: a fluence of 4.99 J/cm²/0.3=16.6 J/cm² should melt a layer of uniform spherical powder, 40 μm thick, when the powder is AlSi10Mg. For a layer of AlSi10Mg powder that is 70 μm thick, the minimum fluence expected to melt is about 16.6 J/cm²*70 μm/40 μm=29.1 J/cm².

In another example, the build material 16 is a TiAl6V4 powder. For TiAl6V4: H_{f}=360 (J/g); c=0.526 (J/g/K); Tₘ=1640° C.; and p=4.42 g/cm³. Assuming n=0.5236; D=40 μm=0.004 cm; and A=1 cm².

### Applying Eq. 8:

m=4.42 (g/cm³)*0.5236*0.004 (cm)*1 (cm²) m=0.00924 (g)

### Applying Eq. 4:

ΔT=1640° C.−25° C.=1615° C.

### Applying Eq. 3:

q=0.00924 (g)*[360 (J/g)+0.526 (J/g/K)*1615° C.]

q=0.00924 (g)*[360 (J/g)+850 (J/g)]

q=0.00924 (g)*1210 (J/g)

q=11.2 J per unit area for a layer that is 40 μm thick.

As mentioned above, the fluence is equal to q divided by the absorptivity of the build material 16, as shown in Eq. 9 and Eq. 10. Absorptivity (A) of TiAl6V4 powder is about 0.64. Applying Eq. 10: a fluence of 11.2 J/cm²/0.64=17.5 J/cm² should melt a layer of uniform spherical powder, 40 μm thick, when the powder is TiAl6V4. For a layer of TiAl6V4 powder that is 70 μm thick, the minimum fluence expected to melt is about 17.5 J/cm²*70 μm/40 μm=30.6 J/cm².

In another example, the build material 16 is a SS316 powder. For SS316: H_{f}=270 (J/g); c=0.466 (J/g/K); Tₘ=1510° C.; and p=7.75 g/cm³.

Assuming n=0.5236; D=40 μm=0.004 cm; and A=1 cm².

### Applying Eq. 8:

m=7.75 (g/cm³)*0.5236*0.004 (cm)*1 (cm²)

m=0.0162 (g)

### Applying Eq. 4:

ΔT=1510° C.−25° C.=1485° C.

Applying Eq. 3:

q=0.0162 (g)*[270 (J/g)+0.466 (J/g/K)*1485° C.]

q=0.0162 (g)*[270 (J/g)+692 (J/g)]

q=0.0162 (g)*962 (J/g)

q=15.6 J per unit area for a layer that is 40 μm thick

Again, the fluence is equal to q divided by the absorptivity of the build material 16, as shown in Eq. 9 and Eq. 10. Absorptivity (A) of SS316 powder is about 0.6. Applying Eq. 10: a fluence of 15.6 J/cm²/0.6=26 J/cm² should melt a layer of uniform spherical powder, 40 μm thick, when the powder is SS316. For a layer of SS316 powder that is 70 μm thick, the minimum fluence expected to melt is about 26 J/cm²*70 μm/40 μm=45.5 J/cm².

In some examples, the determining of the energy function includes adjusting the energy function based on feedback from a consolidation sensor 38. The consolidation sensor 38 may be used to monitor (directly or indirectly) the consolidating transformation of the exposed/corresponding layer Lₖ. For example, the consolidation sensor 38 may monitor a percentage of neck-to-neck sintering in the exposed/corresponding layer Lₖ. As another example, the consolidation sensor 38 may monitor a percentage of melting in the exposed/corresponding layer Lₖ. The consolidation sensor 38 may send feedback from the monitoring to the controller 28. Once the feedback indicates a desired consolidating transformation, the energy function may be adjusted by ending the radiated energy 32. Similarly, if the desired consolidating transformation has not occurred, the energy function may be adjusted by, for example, extending the profile duration 44, 44′ or increasing the intensity.

In an example, the consolidation sensor 38 includes a camera to optically detect a percentage of neck-to-neck sintering in the exposed layer Lₖ. In another example, the consolidation sensor 38 includes a sensor that can detect a characteristic of diffuse reflected or backscattered light (or other electromagnetic radiation) reflected by the exposed/corresponding layer Lₖ. In this example, the consolidation sensor 38 may be used along with an illuminating source such as a light emitting diode or laser to monitor or detect a characteristic of diffuse reflected or backscattered light (or other electromagnetic radiation) reflected by the exposed/corresponding layer Lₖ until the characteristic that corresponds to the desired consolidating transformation is detected. In an example, the characteristic of the diffuse reflected or backscattered light may be an intensity of the diffuse reflected or backscattered light that may be detected with a photodiode or other photodetector. When consolidation occurs, there may be a corresponding, detectable change in the intensity of diffuse reflected or backscattered light. In another example, the consolidation sensor 38 may be an infrared photodiode to detect a change in infrared emissions that is associated with the desired consolidating transformation. For example, the surface temperature of the exposed surface ESₖ may rise steadily as the radiated energy 32 from the flood energy source 34 is applied until a portion of the energy 32 is diverted (from causing the surface temperature to rise) to the consolidating transformation, resulting in a detectable inflection or plateau of the temperature rise trajectory. In another example, the surface temperature of the exposed surface ESₖ may reach a characteristic temperature for a predetermined period of time, the characteristic temperature and the predetermined period of time being associated with the desired consolidating transformation.

In an example, the adjusting of the energy function occurs during the exposing of the exposed surface ESₖ of the exposed layer Lₖ to the radiated energy 32 based on the feedback from the consolidation sensor 38 during the exposing of the exposed surface ESₖ of the exposed layer Lₖ to the radiated energy 32.

In an example, the adjusting of the energy function is based on the feedback from the consolidation sensor 38 stored in a computer memory. Machine learning may be used to adjust the energy function applied to subsequent layers based on feedback from the consolidating transformation of a previous layer.

In some examples, the determining of energy function(s) may be accomplished by the controller 28. In these examples, the controller 28 may determine the energy function(s) according to any of the examples described above.

As shown at reference numeral 106 in FIG. 1, the method 100 includes exposing the exposed surface ESₖ of the exposed layer Lₖ to the radiated energy 32 from the flood energy source 34, thereby causing the consolidating transformation of the build material 16 in the exposed layer Lₖ. As shown in FIG. 2, the method 200 includes sequentially exposing the exposed surface ESₖ of each respective layer Lₖ to the radiated energy 32 from the flood energy source 34, thereby causing the consolidating transformation of the build material 16 in the respective layers.

An enlarged (as compared to FIG. 3A), schematic, and partially cross-sectional cutaway view of an exposed/respective layer Lₖ being exposed to the radiated energy 32 from the flood energy source 34 is shown in FIG. 3C. In the example shown in FIG. 3C, the build material 16 in the layer L₁ having a sequence position of 1 has previously undergone (before layer L₂ was spread over layer 24) a consolidating transformation to form layer 24. FIG. 3C depicts layer 24 as a solid layer, indicating 100% of the particles of the build material 16 in layer 24 have melted to form a solid layer 24. In some examples, complete melting of the first layer L₁ (the layer having a sequence position of 1), may be desirable. In other examples, less than complete melting of the first layer L₁ may be sufficient to achieve the desired intermediate part 36. In an example of the present disclosure, at least 70 percent of the particles of the build material 16 in the layer L₁ having a sequence position of 1 melt to form layer 24.

As also depicted in FIG. 3C, the build material 16 in the layer L₂ having a sequence position of 2 undergoes a consolidating transformation to form layer 26. In FIG. 3C, the consolidating transformation of the build material 16 in the layer L₂ having a sequence position of 2 is depicted as neck-to-neck sintering. As used herein, a percentage of neck-to-neck sintering is based on a percentage of contacts between particles that are sintered. For example, if 1 spherical particle is contacted by 6 adjacent particles, but has neck-to-neck sintering with 3 of the contacting particles, then the percentage of neck-to-neck sintering is 50 percent. In the example of the present disclosure depicted in FIG. 3C, 100 percent of the particles of the build material 16 in the layer L₂ having a sequence position of 2 are sintered neck-to-neck to form layer 26. Therefore, at least 50 percent of particles of the build material 16 in the layer L₂ having a sequence position of 2 are sintered neck-to-neck to form layer 26.

As also shown in FIG. 3C, layer 26 is fused to layer 24. As used herein, fusion between layers means at least 50 percent of the particles in a sintered layer are attached to an adjacent layer to form a solid piece. In examples, the fusion may occur by sintering at a temperature below the melting point of the build material 16. In other examples, the fusion between layers may include melting of a portion of either adjacent layer. For example, a portion of the particles in layer 26 may melt and solidify with layer 24, and a portion of solidified layer 24 may melt and solidify with the particles in layer 26. The fusion between layers may be similar to neck-to-neck sintering, except one layer may not have separately discernable particles.

In some examples, the exposing of the exposed surface ES₁ of the layer L₁ having a sequence position of 1 to the radiated energy 32 from the flood energy source 34 attaches the layer 24 formed therefrom to the build area platform 12. In these examples, the first layer 24 is fused to the build area platform 12. In some other examples, the first layer 24 may attached to the build area platform 12 with chemical adhesives. The chemical adhesives may be thermally activated. In still other examples, the first layer 24 may be attached to the build area platform 12 in any suitable manner. It may be desirable to attach the first layer 24 to the build area platform 12 to prevent cracks from forming in the layer 24. The build area platform 12 may include a replaceable portion, such as a platen or glass plate. In examples where the first layer 24 is attached to the build area platform 12, the portion of the build area platform 12 that is attached to the intermediate part 36 may be removed by mechanical machining, polishing, etching, dissolving, melting, ablation or any suitable technique. In an example, a frangible layer may be included between the intermediate part 36 and the portion of the build area platform 12 that is to be detached from the intermediate part 36.

In some examples, the amount of energy used to cause the consolidating transformation of the sequence 50 of layers may be less than an amount of energy sufficient to cause the same consolidating transformation of the sequence 50 of layers using selective laser sintering (SLS). In one of these examples, the amount of energy used to cause the consolidating transformation of the sequence 50 of layers may be about 10× (i.e., 10 times) less than an amount of energy sufficient to cause the same consolidating transformation of the sequence 50 of layers using selective laser sintering. As such, examples of the methods 100, 200 for additive manufacturing of metals may be more energy efficient than selective laser sintering.

The consolidating transformation of the sequence 50 of layers may form intermediate part layers (e.g., layer 24 and layer 26), and ultimately an intermediate part 36 (see FIG. 4). The intermediate part 36, shown in FIG. 4, includes the layer 24, the layer 26, and additional layers established thereon.

As used herein, the term “intermediate part” refers to a part precursor that has a shape representative of the final 3D part, and that includes build material 16 that has undergone consolidating transformation. In the intermediate part 36, the build material 16 is bound due to its at least partial melting or sintering. The at least partial melting or sintering may be neck-to-neck melting or neck-to-neck sintering. It is to be understood that any build material 16 that has not undergone consolidating transformation is not considered to be part of the intermediate part 36, even if it is adjacent to or surrounds the intermediate part 36. In these examples, the consolidating transformation of the build material 16 provides the intermediate part 36 with enough mechanical strength that it is able to be handled or to withstand extraction from the build area platform 12 without being deleteriously affected (e.g., the shape is not lost, damaged, etc.).

The intermediate part 36 may also be referred to as a “green” part, but it is to be understood that the term “green” when referring to the intermediate/green part or does not connote color, but rather indicates that the part is not yet fully processed.

While not shown in the Figures, examples of the methods 100, 200 may further include heating the intermediate part 36 to form a final part. As used herein the term “final part” refers to a part that is able to be used for its desired or intended purpose. Examples of the final part may include melted and/or sintered build material 16 particles that have merged together to form a continuous body. By “continuous body,” it is meant that the build material 16 particles are merged together to form a single part with sufficient mechanical strength to be used for the desired or intended purpose of the final part.

In some examples, the intermediate part 36 may be extracted from the build area platform 12 and placed in a heating mechanism (e.g., an oven). The heating mechanism may be used to heat the intermediate part 36 to form the final part.

The final part may be formed by applying heat to sinter the metal in the intermediate part 36. Sintering may be performed in stages, where initial, lower sintering temperatures can result in the formation of weak bonds that are strengthened during final sintering. The initial sintering temperature may be selected to densify the intermediate part 36 and to decrease or eliminate any porosity throughout the intermediate part 36. The initial sintering temperature may be capable of softening the metal. The initial sintering temperature may thus be dependent upon the metal used in the build material 16. Moreover, the initial sintering temperature may also be dependent on the sintering rate of the metal. For example, metal powders with a smaller particle size can be sintered at a higher rate at lower temperatures than powders of the same metal with a larger particle size.

During final sintering, the metal particles continue to coalesce to form the final part having a desired density. The final sintering temperature is a temperature that is sufficient to sinter the remaining metal particles.

The sintering temperature may depend upon the composition of the metal particles. During final sintering, the intermediate part 36 may be heated to a temperature ranging from about 80% to about 99.9% of the melting point(s) of the metal. In another example, the intermediate part 36 may be heated to a temperature ranging from about 90% to about 95% of the melting point(s) of the metal. In still another example, the intermediate part 36 may be heated to a temperature ranging from about 60% to about 90% of the melting point(s) of the metal. In yet another example, the final sintering temperature may range from about 10° C. below the melting temperature of the metal to about 50° C. below the melting temperature of the metal. In still another example, the final sintering temperature may range from about 100° C. below the melting temperature of the metal to about 200° C. below the melting temperature of the metal. The final sintering temperature may also depend upon the particle size and time for sintering (i.e., high temperature exposure time).

As an example, the sintering temperature may range from about 500° C. to about 1800° C. In another example, the sintering temperature is at least 900° C. An example of a final sintering temperature for bronze is about 850° C., and an example of a final sintering temperature for stainless steel is about 1400° C., and an example of a final sintering temperature for aluminum or aluminum alloys may range from about 550° C. to about 670° C. While these temperatures are provided as final sintering temperature examples, it is to be understood that the final sintering temperature depends upon the metal that is utilized, and may be higher or lower than the provided examples.

Heating at a suitable final sintering temperature sinters and fuses the metal to form the final part, which may be densified relative to the intermediate part 36. For example, as a result of final sintering, the density may go from 50% density to over 90%, and in some cases, very close to 100% of the theoretical density.

The length of time for which the heat (for sintering) is applied and the rate at which the intermediate part 36 is heated may be dependent, for example, on one or more of: characteristics of the heating mechanism, characteristics of the metal particles (e.g., metal type, particle size, etc.), and/or the characteristics of the intermediate part 36 (e.g., wall thickness). The intermediate part 36 may be heated at the sintering temperature(s) for respective time periods ranging from about 20 minutes to about 15 hours. In an example, each time period is 60 minutes. In another example, each time period is 90 minutes. The intermediate part 36 may be heated to each of the initial sintering temperature and the final sintering temperature at a rate ranging from about 1° C./minute to about 20° C./minute.

In some examples, the heating of the intermediate part 36 to form the final part is accomplished in an environment containing an inert gas, a low reactivity gas, a reducing gas, or a combination thereof. Sintering may be accomplished in such an environment so that the metal will sinter rather than undergoing an alternate reaction (e.g., an oxidation reaction) which would fail to produce the final part.

Build Materials

As mentioned above, the build material 16 includes a metal. The metal may be in powder form, i.e., particles. In the present disclosure, the term “particles” means discrete solid pieces of components of the build material 16. As used herein, the term “particles” does not convey a limitation on the shape of the particles. As examples, the metal particles may be non-spherical, spherical, random shapes, or combinations thereof.

The metal particles may also be similarly sized particles or differently sized particles. The individual particle size of each of the metal particles may be up to 100 μm. In an example, the metal particles may have a particle size ranging from about 1 μm to about 100 μm. In another example, the individual particle size of the metal particles ranges from about 1 μm to about 30 μm. In still another example, the individual particle size of the metal particles ranges from about 2 μm to about 50 μm. In yet another example, the individual particle size of the metal particles ranges from about 5 μm to about 15 μm. As used herein, the term “individual particle size” refers to the particle size of each individual build material particle. As such, when the metal particles have an individual particle size ranging from about 1 μm to about 100 μm, the particle size of each individual metal particle is within the disclosed range, although individual metal particles may have particle sizes that are different than the particle size of other individual metal particles. In other words, the particle size distribution may be within the given range. The particle size of the metal particles refers to the diameter or volume weighted mean/average diameter of the metal particle, which may vary, depending upon the morphology of the particle.

In an example, the metal may be a single phase metallic material composed of one element. In this example, the sintering temperature of the build material 16 may be below the melting point of the single element. In another example, the metal may be composed of two or more elements, which may be in the form of a single phase metallic alloy or a multiple phase metallic alloy. In these other examples, sintering may occur over a range of temperatures.

Some examples of the metal include steels, stainless steel, bronzes, titanium (Ti) and alloys thereof, aluminum (Al) and alloys thereof, nickel (Ni) and alloys thereof, cobalt (Co) and alloys thereof, iron (Fe) and alloys thereof, nickel cobalt (NiCo) alloys, gold (Au) and alloys thereof, silver (Ag) and alloys thereof, platinum (Pt) and alloys thereof, and copper (Cu) and alloys thereof. Some specific examples include AlSi10Mg, 2xxx series aluminum, 4xxx series aluminum, CoCr MP1, CoCr SP2, Maraging Steel MS1, Hastelloy C, Hastelloy X, Nickel Alloy HX, Inconel IN625, Inconel IN718, SS (Stainless Steel) GP1, SS 17-4PH, SS316, SS 316L, SS 430L, Ti6Al4V (also known as TiAl6V4), and Ti-6Al-4V ELI7. While several example alloys have been provided, it is to be understood that other alloys may be used.

In one example, the metal is AlSi10Mg. AlSi10Mg is an aluminum alloy including: from 9 weight percent (wt %) to 11 wt % of Si; from 0.2 wt % to 0.45 wt % of Mg; 0.55 wt % or less of Fe; 0.05 wt % or less of Cu; 0.45 wt % or less of Mn; 0.05 wt % or less of Ni; 0.1 wt % or less of Zn; 0.05 wt % or less of Pb; 0.05 wt % or less of Sn; 0.15 wt % or less of Ti; and a balance of Al. When the metal is AlSi10Mg, the metal may be suited for thermal and/or low weight applications.

In another example, the metal is TiAl6V4. TiAl6V4 is a titanium alloy including: from 5.5 wt % to 6.75 wt % of Al; from 3.5 wt % to 4.5 wt % of V; 0.3 wt % or less of Fe; 0.08 wt % or less of C; 0.05 wt % or less of N; 0.2 wt % or less of 0; 0.015 wt % or less of H; and a balance of Ti. When the metal is TiAl6V4, the metal may be suited for high strength and/or low density applications.

In still another example, the metal is SS316. SS316 is a stainless steel including: from 16 wt % to 18 wt % of Cr; from 10 wt % to 14 wt % of Ni; from 2 wt % to 3 wt % of Mo; 0.08 or less of C; 2 wt % or less Mn; 0.75 or less of Si; 0.045 wt % or less P; 0.03 wt % or less S; 0.1 wt % or less N; and a balance of Fe.

Three Dimensional (3D) Printers

Referring now to FIG. 4, an example of a 3D printer 10 is schematically depicted. It is to be understood that the 3D printer 10 may include additional components (some of which are described herein) and that some of the components described herein may be removed and/or modified. Furthermore, components of the 3D printer 10 depicted in FIG. 4 is schematic, and may not be drawn to scale. Thus, the 3D printer 10 may have a different size and/or configuration other than as shown therein.

In an example, the three dimensional (3D) printer 10, comprises: a build material distributor 18 to spread a build material 16 including a metal in a sequence 50 of layers, each layer Lₖ having a respective thickness dₖ, a respective sequence position k, and a respective exposed surface ESₖ; a flood energy source 34 to radiate energy to be received at the respective exposed surface ESₖ of each layer Lₖ prior to a spreading of a subsequent layer Lₖ₊₁ by the build material distributor 18; a controller 28 to determine a series of energy functions corresponding to the sequence 50 of layers, each energy function in the series of energy functions based on the metal, the thickness dₖ and the sequence position k of the corresponding layer Lₖ and a consolidation status of an exposed layer Lₖ, each energy function defining the energy 32 to be radiated by the flood energy source 34, and including an intensity profile 40, 40′ and a fluence sufficient to cause a consolidating transformation of the build material 16 in the corresponding layer Lₖ; and a consolidation sensor 38 connected to the controller 28, the consolidation sensor 38 to detect the consolidation status of an exposed layer Lₖ.

In some examples, the 3D printer 10 may further include a supply 14 of a build material 16; and/or a non-transitory computer readable medium having stored thereon computer executable instructions to cause the controller 28 to: utilize the build material distributor 18 to spread the build material 16 in a sequence 50 of layers, each layer Lₖ having a respective thickness dₖ, a respective sequence position k, and a respective exposed surface ESₖ to receive energy from the flood energy source 34 prior to spreading of a subsequent layer Lₖ₊₁; determine the series of energy functions; utilize the flood energy source 34 to expose each layer Lₖ to radiated energy 32 to cause the consolidating transformation of the build material 16 in each layer Lₖ prior to the spreading of the subsequent layer Lₖ₊₁; and/or utilize the consolidation sensor 38 to detect the consolidation status of the exposed layer Lₖ.

As shown in FIG. 4, the 3D printer 10 may include the build area platform 12, the build material supply 14 containing the build material 16, and the build material distributor 18.

As mentioned above, the build area platform 12 receives the build material 16 from the build material supply 14. The build area platform 12 may be integrated with the 3D printer 10 or may be a component that is separately insertable into the 3D printer 10. For example, the build area platform 12 may be a module that is available separately from the 3D printer 10. The build area platform 12 that is shown is one example, and could be replaced with another support member, such as a platen, a fabrication/print bed, a glass plate, or another build surface.

As also mentioned above, the build material supply 14 may be a container, bed, or other surface that is to position the build material 16 between the build material distributor 18 and the build area platform 12. In some examples, the build material supply 14 may include a surface upon which the build material 16 may be supplied, for instance, from a build material source (not shown) located above the build material supply 14. Examples of the build material source may include a hopper, an auger conveyer, or the like. Additionally, or alternatively, the build material supply 14 may include a mechanism (e.g., a delivery piston) to provide, e.g., move, the build material 16 from a storage location to a position to be spread onto the build area platform 12 or onto a previously formed layer of the intermediate part 36.

As also mentioned above, the build material distributor 18 may be a blade (e.g., a doctor blade), a roller, a combination of a roller and a blade, and/or any other device capable of spreading the build material 16 over the build area platform 12 (e.g., a counter-rotating roller).

In some examples, the build material supply 14 or a portion of the build material supply 14 may translate along with the build material distributor 18 such that build material 16 is delivered continuously to the build material distributor 18 rather than being supplied from a single location at the side of the 3D printer 10 as depicted in FIG. 4.

As shown in FIG. 4, the 3D printer 10 also includes a flood energy source 34. In some examples, the flood energy source 34 may be in a fixed position with respect to the build area platform 12. In these examples, the flood energy source 34 is capable of exposing an entire layer Lₖ of build material 16 to the radiated energy 32 of energy from its fixed position. As examples, the flood energy source 34 may be positioned from 5 mm to 150 mm, 25 mm to 125 mm, 75 mm to 150 mm, 30 mm to 70 mm, or 10 mm to 20 mm away from the exposed layer Lₖ during operation.

The flood energy source 34 is capable of generating radiated energy 32 at an intensity profile 40, 40′ and fluence sufficient to cause the consolidating transformation of the build material 16. In an example, the flood energy source 34 is capable of emitting radiated energy 32 with an intensity ranging from greater than 0 kW/cm² to about 50 kW/cm². In another example, the flood energy source 34 is capable of emitting radiated energy 32 with a fluence ranging from greater than 0 J/cm² to about 100 J/cm².

In an example, the flood energy source 34 is a pulse gas discharge lamp, such as a xenon flashtube, a krypton flash tube, an argon flashtube, a neon flashtube, or a flashtube including a combination of xenon, krypton, argon, and neon. In another example, the flood energy source 34 is a xenon pulse lamp. In yet another example, the flood energy source 34 is an array of fiber lasers, such as a laser including an optical fiber doped with erbium, ytterbium, neodymium, dysprosium, praseodymium, thulium, or holmium. In yet another example, the flood energy source 34 is a semiconductor laser, a gas laser, an array of the semiconductor lasers, or an array of the gas lasers. In an example, the gas laser is a high-power CO₂ (carbon dioxide) laser or Ar (argon) laser. It is to be understood that the flood energy source 34, no matter what principle of operation the flood energy source 34 uses, is capable of exposing an entire layer of build material 16 to the radiated energy 32 without scanning during the exposing.

As shown in FIG. 4, the 3D printer 10 also includes a consolidation sensor 38 as disclosed herein above.

Each of the previously described physical elements may be operatively connected to a controller 28 of the 3D printer 10. The controller 28 may process manufacturing data that is based on a 3D object model of the 3D object/part to be generated. In response to data processing, the controller 28 may control the operations of the build area platform 12, the build material supply 14, the build material distributor 18, and the flood energy source 34. As an example, the controller 28 may control actuators (not shown) to control various operations of the 3D printer 10 components. The controller 28 may be a computing device, a semiconductor-based microprocessor, a central processing unit (CPU), an application specific integrated circuit (ASIC), and/or another hardware device. The controller 28 may be connected to the 3D printer components via hardware communication lines, or wirelessly via radio or photonic communication.

The controller 28 manipulates and transforms data, which may be represented as physical (electronic) quantities within the printer's registers and memories, in order to control the physical elements to create the 3D part. As such, the controller 28 is depicted as being in communication with a data store 30. The data store may also be referred to as a computer memory. The data store 30 may include data pertaining to a 3D part to be manufactured by the 3D printer 10. The data for the selective delivery of the build material 16, etc. may be derived from a model of the 3D part to be formed. The data store 30 may also include machine readable instructions (stored on a non-transitory computer readable medium) that are to cause the controller 28 to control the amount of build material 16 that is supplied by the build material supply 14, the movement of the build area platform 12, the movement of the build material distributor 18, etc.

While one controller 28 is shown in FIG. 4, it is to be understood that multiple controllers may be used. For example, one controller may control the build area platform 12, the build material supply 14, and the build material distributor 18, and another controller (e.g., controller 28) may control the flood energy source 34 and the consolidation sensor 38.

To further illustrate the present disclosure, examples are given herein. It is to be understood these examples are provided for illustrative purposes and are not to be construed as limiting the scope of the present disclosure.

### EXAMPLES

### Example 1

An example intermediate part (i.e., the first example part) was manufactured. An AlSi10Mg powder (from LPW, LPW-AlSi10MG-AABJ) with a particle size of 20 μm to 63 μm was used as the build material. AlSi10Mg has: a heat of fusion (H_{f}) of 321 J/g; a specific heat (c) of 0.897 J/g/K; a melting point (Tₘ) of 660° C.; a density (ρ) of 2.68 g/cm³; and absorptivity (A) of about 0.3.

The AlSi10Mg powder was spread on a glass substrate in a sequence of 6 layers, each layer having the respective thickness shown in Table 1. The sequence position of each layer is shown in Table 1 with the corresponding thickness. The layer at sequence position 1 was spread directly onto the glass substrate.

TABLE 1

| Layer sequence | Micrometer | Layer |
|---|---|---|
| position | setting | thickness |
| 6 | 5800 μm | 100 μm |
| 5 | 5700 μm | 70 μm |
| 4 | 5630 μm | 70 μm |
| 3 | 5560 μm | 70 μm |
| 2 | 5490 μm | 70 μm |
| 1 | 5420 μm | 70 μm |

Each layer was exposed to radiated energy using a PulseForge® 1300 as the flood energy source. The minimum fluence expected to melt a 70 μm thick layer of AlSi10Mg powder was 29.1 J/cm² (calculated by applying the heat of fusion (H_{f}), specific heat (c), melting point (Tₘ), density (ρ), and absorptivity (A) of AlSi10Mg, assuming D=40 μm, unit area=1 cm², and n=0.5236 into Eq. 8, Eq. 4, Eq. 3, and Eq. 10).

In experiments with AlSi10Mg powder, the inventors found that the threshold of sintering was about the same as the theoretical minimum fluence expected to melt (about 30 J/cm²) when the thickness (and therefore the mass) was accounted for. Thus, the theoretical minimum fluence, based on Eq. 8, Eq. 4, Eq. 3 and Eq. 10, was not enough to completely melt the AlSi10Mg powder.

Further, it was found, in experiments on stainless steel powders by the inventors, that cracks may be avoided by 1) firmly attaching the first layer to the glass substrate, and 2) avoiding Marangoni effect by preventing the surface temperature from getting too high by keeping the intensity low relative to the absorptivity during the application of the radiated energy. Firm attachment to the first layer may be accomplished in any suitable manner, including, for example, by chemical adhesives or fusion of the powder in contact with the substrate.

Experiments by the inventors have shown that fusion of the first layer of AlSi10Mg to the glass substrate, which results in a mirror like appearance when viewed through the glass substrate, was achievable using the PulseForge® 1300 when the fluence was at least 40 J/cm² when the thickness was about 80 μm. Higher fluence tended to increase the fusion. Therefore, the fluence that was sufficient to melt the first layer was higher than predicted by the theoretical calculations using Eq. 8, Eq. 4, Eq. 3, and Eq. 10.

The intensity profile to deliver the fluence for each of the 6 layers of Example 1 was determined based on the operating characteristics of the flood energy source (PulseForge® 1300). The intensity profile was, in part, determined by the Xenon lamp cooling capability in the PulseForge® 1300. Prior experiments performed by the inventors have shown that PulseForge® 1300 at 700 Volts creates an exponentially decaying intensity profile, with an initial (peak) intensity of 13 kW/cm². A fluence of 50 J/cm² resulted from an 18 msec intensity profile duration where the radiated energy was divided into 20 slices at a 91% duty cycle as depicted in FIG. 5.

In Example 1, each layer was spread and exposed, in turn, to the radiated energy having the intensity profile depicted in FIG. 5. Each layer was examined after the exposure to the radiated energy. The first layer was well attached to the glass substrate, and layers 2-6 each had good fusion. Starting at the fourth layer, some of the edges were weak where the edge of the subsequent layer extended beyond the edge of the layers below. This resulted in the overhanging edges of the subsequent layers being about 280 μm thick, which may have been too thick for good fusion. On the fourth layer (but on no other layer), a second stage of the intensity profile was applied, but there was almost no change in the fusion of the fourth layer.

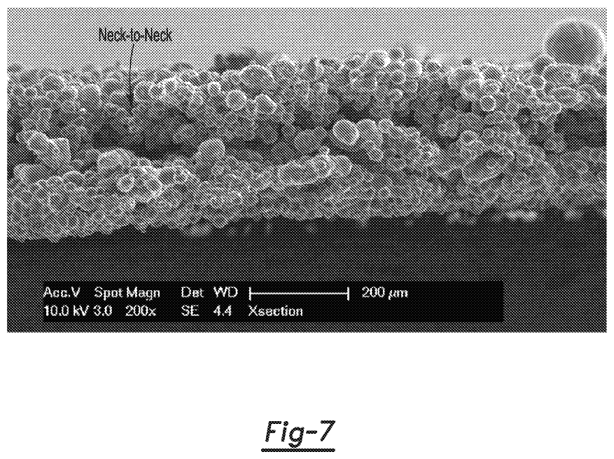

FIG. 7 shows a SEM image, at 200 times magnification, of a cross-section of an example intermediate part similar to the first example part. The example part shown in FIG. 7 was produced by spreading AlSi10Mg powder on a glass substrate in a sequence of 5 layers and exposing each layer to radiated energy from the PulseForge® 1300. As shown in FIG. 7, the upper layers (i.e., the layers in sequence positions 2-5) have been neck-to-neck sintered. As also shown in FIG. 7, the first layer (i.e., the layer in sequence position 1) has been melted.

### Example 2

Another example intermediate part (i.e., the second example part) was manufactured. A TiAl6V4 powder (from Goodfellow, TI016075) with a maximum particle size of 45 μm was used as the build material. TiAl6V4 has: a heat of fusion (H_{f}) of 360 J/g; a specific heat (c) of 0.526 J/g/K; a melting point (Tₘ) of 1640° C.; and a density (ρ) of 4.42 g/cm³; and absorptivity (A) of about 0.64.

The TiAl6V4 powder was spread on a glass substrate in a sequence of 2 layers. The layers had a non-uniform thickness that tapered from thick to 0 μm. The layer at sequence position 1 was spread directly onto the glass substrate.

Each layer was exposed to radiated energy using the PulseForge® 1300 as the flood energy source. The minimum fluence expected to melt a 70 μm thick layer of TiAl6V4 powder was 30.6 J/cm² (calculated by applying the heat of fusion (H_{f}), specific heat (c), melting point (Tₘ), density (ρ), and absorptivity (A) of TiAl6V4, assuming D=40 μm, unit area=1 cm², and n=0.5236 into Eq. 8, Eq. 4, Eq. 3, and Eq. 10).

In experiments with TiAl6V4 powder, the inventors found that the threshold of sintering was about the same as the theoretical minimum fluence expected to melt (about 30 J/cm²). Thus, the theoretical minimum fluence, based on Eq. 8, Eq. 4, Eq. 3, and Eq. 10, was not enough to completely melt the TiAl6V4 powder.

Further, the inventors determined that the relatively low thermal conductivity of the TiAl6V4 powder prevents the heat from penetrating through a thick layer quickly enough to completely melt the powder.

Through experiments with various energy functions, the inventors found that a uniform sinter, characterized by a uniform gray color, was possible with lower intensity and a fluence of 30 J/cm². Further, a uniform melt, characterized by a mirror like reflective surface, was also possible at a higher intensity at the same fluence of 30 J/cm². A thin layer (about 15 μm) attached to glass slide. A medium thick layer cracked. A thick layer was uniform even under high intensity.

Experiments by the inventors have shown that fusion of thin portions of the first layer of TiAl6V4 to the glass substrate, which results in a mirror like appearance when viewed through the glass substrate, was achievable using the PulseForge® 1300 when the fluence was at least 30 J/cm² when the thickness was about under 15 μm. Higher fluence tended to increase the depth and uniformity of fusion of the exposed layer of the TiAl6V4. It is further noted that mm-size Marangoni effect cracks did not occur, even under high intensity (30 kW/cm²) when the fluence was kept at 30 J/cm².

The intensity profile to deliver the fluence for each of the 2 layers of Example 2 was determined based on the operating characteristics of the flood energy source (PulseForge® 1300). The intensity profile was limited by the Xenon lamp cooling capability in the PulseForge® 1300. Prior experiments performed by the inventors have shown that PulseForge® 1300 at 700 Volts creates an exponentially decaying intensity profile, with an initial (peak) intensity of 13 kW/cm². A fluence of 30 J/cm² resulted from a 10 msec intensity profile duration where the radiated energy was divided into 10 slices at about a 55% duty cycle as depicted in FIG. 6.

In Example 2, the first layer was spread and exposed to the radiated energy having the intensity profile depicted in FIG. 6. The second layer was also exposed to a fluence of 30 J/cm², however, the intensity profile had a peak intensity of 30 kW/cm², a duration of 10 msec, and was divided into 10 slices. In Example 2, a uniform thickness was not achieved in the layers. The gradient in thickness allowed the effect of thickness on the consolidating transformation to be studied. Each layer was examined after the exposure to the radiated energy. The thin areas of the first layer were melted, shiny, and well attached to the glass substrate. Thicker areas were gray and sintered, with some curvature away from the glass substrate in the thickest parts of the layer. After cutting off the curved-up portion of the first layer, the second layer was spread over the first layer. The second layer, therefore, had even more nonuniformity of thickness. After exposure to the radiated energy, much of the second layer was melted and shiny, and the rest was sintered and gray. A significant crack occurred across the entire second layer. The second layer did not attach well to the first layer. It is believed that the lack of attachment could have been improved by increasing the temperature to compensate for the low heat conductivity of the TiAl6V4, or by having uniformly thin layers.

### Example 3

An example intermediate part was manufactured. A SS316 powder (from LPW, LPW-316-AAAV) with a particle size of 15 μm to 45 μm was used as the build material. SS316 has: a heat of fusion (H_{f}) of 270 J/g; a specific heat (c) of 0.466 J/g/K; a melting point (Tₘ) of 1510° C.; and a density (ρ) of 7.75 g/cm³; and absorptivity (A) of about 0.6 (first stage).

The SS316 powder was spread directly onto a glass substrate. The layer was exposed to radiated energy using the PulseForge® 1300 as the flood energy source. The minimum fluence expected to melt a 40 μm thick layer of SS316 powder was 26 J/cm² (calculated by applying the heat of fusion (H_{f}), specific heat (c), melting point (Tₘ), density (ρ), and absorptivity (A) of SS316, assuming D=40 μm, unit area=1 cm², and n=0.5236 into Eq. 8, Eq. 4, Eq. 3, and Eq. 10).

In experiments with SS316 powder, the inventors found that the theoretical minimum fluence expected to melt (about 30 J/cm²) did cause nearly full melting of the powder particles at the center region of the exposed surface, and attachment of particles that contacted the melted particles from the exposed surface. The melted center region of the exposed area had significant cracks. The perimeter of the exposed layer was sintered at various degrees. The melted center region (with cracks) resulted from operating the PulseForge® 1300 at 700 Volts creating an exponentially decaying intensity profile, with an initial (peak) intensity of 13 kW/cm². A fluence of 30 J/cm² resulted from a 4 msec intensity profile duration where the intensity profile was divided into 2 slices at an 86% duty cycle.

Through experiments with various intensity profiles, the inventors found that a uniform sinter, characterized by a uniform gray color without cracks, resulted from the PulseForge® 1300 at 650 Volts creating an exponentially decaying intensity profile, with an initial (peak) intensity of 10 kW/cm² and a fluence of 37 J/cm² from a single stage with a profile duration of 10 msec.

It is to be understood that the ranges provided herein include the stated range and any value or sub-range within the stated range, as if the value(s) or sub-range(s) within the stated range were explicitly recited. For example, a range greater than 0 kW/cm² to about 50 kW/cm² should be interpreted to include the explicitly recited limits of greater than 0 kW/cm² to about 50 kW/cm², as well as individual values, such as 5.73 kW/cm², 26 kW/cm², 47.2 kW/cm², etc., and sub-ranges, such as from about 5.25 kW/cm² to about 44.25 kW/cm², from about 16 kW/cm² to about 48.75 kW/cm², from about 3.5 kW/cm² to about 40 kW/cm², etc. Furthermore, when “about” is utilized to describe a value, this is meant to encompass minor variations (up to +/−10%) from the stated value. As used herein, the term “few” means about three.

Reference throughout the specification to “one example”, “another example”, “an example”, and so forth, means that a particular element (e.g., feature, structure, and/or characteristic) described in connection with the example is included in at least one example described herein, and may or may not be present in other examples. In addition, it is to be understood that the described elements for any example may be combined in any suitable manner in the various examples unless the context clearly dictates otherwise.

In describing and claiming the examples disclosed herein, the singular forms “a”, “an”, and “the” include plural referents unless the context clearly dictates otherwise.

While several examples have been described in detail, it is to be understood that the disclosed examples may be modified. Therefore, the foregoing description is to be considered non-limiting.

What is claimed is:

1. A method for additive manufacturing of metals, comprising:
spreading a build material including a metal in a sequence of layers, each layer having a respective thickness, a respective sequence position, and a respective exposed surface to receive radiated energy from a flood energy source prior to spreading of a subsequent layer;
determining an energy function based on the metal, the thickness, and the sequence position of an exposed layer, the energy function defining the radiated energy and including an intensity profile and a fluence sufficient to cause a consolidating transformation of the build material in the exposed layer; and
exposing the exposed surface of the exposed layer to the radiated energy from the flood energy source, thereby causing the consolidating transformation of the build material in the exposed layer.

2. The method as defined in claim 1 wherein:
the intensity profile includes:
an intensity; a profile duration; and a number of profile slices; and
the determining the energy function includes:
determining a minimum energy to sinter the exposed layer;
determining an absorptivity of the exposed layer for the radiated energy;
determining an amount of energy propagated to other layers from or through the exposed layer; and
determining a maximum allowable intensity to limit Marangoni effect cracks in the exposed layer.

3. The method as defined in claim 2 wherein the minimum energy to sinter the exposed layer is determined from:
a heat capacity of the build material;
a heat of fusion of the build material;
a melting point of the build material;
a packing density of the build material; and
a thickness of the exposed layer.

4. The method as defined in claim 2 wherein the amount of energy propagated to other layers from or through the exposed layer is determined from a thermal conductivity of the build material.

5. The method as defined in claim 1 wherein:
the consolidating transformation includes:
a neck-to-neck sintering of at least 50 percent of particles in the build material of the exposed layer having a sequence position greater than 1; and
a fusion between the exposed layer having a sequence position greater than 1 and the layer having a sequence position one less than the sequence position of the exposed layer; and
the consolidating transformation is a melting of at least 70 percent of the particles in the build material of a layer having a sequence position of 1.

6. The method as defined in claim 1 wherein the determining the energy function includes adjusting the energy function based on feedback from a consolidation sensor.

7. The method as defined in claim 6 wherein the consolidation sensor includes a camera to optically detect a percentage of neck-to-neck sintering in the exposed layer.

8. The method as defined in claim 6 wherein the adjusting of the energy function occurs during the exposing of the exposed surface of the exposed layer to the radiated energy based on the feedback from the consolidation sensor during the exposing of the exposed surface of the exposed layer to the radiated energy.

9. The method as defined in claim 6 wherein the adjusting of the energy function is based on the feedback from the consolidation sensor stored in a computer memory.

10. A method for additive manufacturing of metals, comprising:
spreading a build material including a metal in a sequence of layers, each layer having a respective thickness, a respective sequence position, and a respective exposed surface to receive radiated energy from a flood energy source prior to spreading of a subsequent layer;
determining a series of energy functions corresponding to the sequence of layers, each energy function in the series of energy functions based on the metal, the thickness and the sequence position of the corresponding layer, each energy function defining the radiated energy and including an intensity profile and a fluence sufficient to cause a consolidating transformation of the build material in the corresponding layer; and
sequentially exposing the exposed surface of each respective layer to the radiated energy from the flood energy source, thereby causing the consolidating transformation of the build material in the respective layers.

11. The method as defined in claim 10 wherein:
the intensity profile of each energy function includes:
an intensity; a profile duration; and a number of profile slices; and
the determining the series of energy functions includes:
determining a minimum energy to sinter the corresponding layer;
determining an absorptivity of the corresponding layer for the radiated energy;
determining an amount of energy propagated to other layers from or through the corresponding layer; and
determining a maximum allowable intensity to limit Marangoni effect cracks in the corresponding layer.

12. The method as defined in claim 11 wherein:
the minimum energy to sinter the corresponding layer is determined from:
a heat capacity of the build material;
a heat of fusion of the build material;
a melting point of the build material;
a packing density of the build material; and
a thickness of the corresponding layer; and
the amount of energy propagated to other layers from or through the corresponding layer is determined from a thermal conductivity of the build material.

13. The method as defined in claim 10 wherein:
the consolidating transformation includes:
a neck-to-neck sintering of at least 50 percent of particles in the build material of the respective layer having a sequence position greater than 1; and
a fusion between the respective layer having a sequence position greater than 1 and the layer having a sequence position one less than the sequence position of the respective layer; and
the consolidating transformation is a melting of at least 70 percent of the particles in the build material of a layer having a sequence position of 1.

14. The method as defined in claim 10 wherein the determining the energy function includes adjusting the energy function based on feedback from a consolidation sensor.

15. A three dimensional (3D) printer, comprising:
a build material distributor to spread a build material including a metal in a sequence of layers, each layer having a respective thickness, a respective sequence position, and a respective exposed surface;
a flood energy source to radiate energy to be received at the respective exposed surface of each layer prior to a spreading of a subsequent layer by the build material distributor;
a controller to determine a series of energy functions corresponding to the sequence of layers, each energy function in the series of energy functions based on the metal, the thickness and the sequence position of the corresponding layer and a consolidation status of an exposed layer, each energy function defining the energy to be radiated by the flood energy source, and including an intensity profile and a fluence sufficient to cause a consolidating transformation of the build material in the corresponding layer; and
a consolidation sensor connected to the controller, the consolidation sensor to detect the consolidation status of an exposed layer.
